(19) United States
(12) Patent Application Publication
(10) Pub. No.: US 2003/0030320 A1
(43) Pub. Date: Feb. 13, 2003

(54) Blank hubcaps

(76) Inventor: John D. Smith, Orlando, FL (US)

Correspondence Address: LAW OFFICES OF BRIAN S STEINBERGER, 101 BREVARD AVENUE, COCOA, FL, 32922, US

(21) Appl. No.: 10/008,266

(22) Filed: Oct. 29, 2001

Related U.S. Application Data
(63) Continuation-in-part of application No. 09/627,835, filed on Jul. 28, 2000, now Pat. No. 6,309,027.

(51) Int. Cl. B60B 7/00

(52) U.S. Cl. 301/37.42

(57) ABSTRACT

Removable decorative wheel covers for covering central wheel portions on wheels on various types of moving vehicles from automobiles to buses to trucks to golf carts. The covers can have perforated patterns that can be punched out as needed to allow different sized wheel protrusions such as valve stems, central raised hub members, and the like, to pass therethrough. The perforations can include a single pattern, a ring pattern, and the like. A novel blank wheel cover can allow for customizable indicia to be applied by various methods including stencils, peel & stick decals, static cling decals, and/or magnetic decals to be selectively applied thereon. Another version allows for removable fasteners to be on both sides of the discs so that the user can selectively make either side of the disc visible.

This invention relates to wheel covers, and in particular to detachable decorative wheel covers that can fit over different types of vehicle wheels and include blank surfaces for allowing customized indicia to be added by stickers, decals, markers, magnets, and the like, and the covers can have removable portions that allow protrusions such as air valve stems, and center raised hubs to pass therethrough, and this invention is a Continuation-In-Part of U.S. application Ser. No. 09/627,835 filed Jul. 28, 2000. The invention is related to U.S. Pat. No. 5,931,543 to Smith, the same inventor of the subject invention, which is incorporated by reference.

### BACKGROUND AND PRIOR ART

Applying indicia such as advertisements to vehicles by using decals can generally damage the painted surfaces of the vehicles, and/or the bumpers. Decorative wheel covers for automobiles, and trucks, and the like, have generally been restricted to fixed patterns such as engraved patterns in metal surfaces and plastic surfaces, or are restricted to pre-patterned panels. Additionally, wheel covers have generally been restricted to plastic and metal type hubcaps having bendable insertable edges for covering and protecting wheel hubs. See for example: U.S. Pat. Des. 170,114 to Dieterich; Des. 370,198 to Starr, Sr. et al.; 2,124,789 to Lyon; 2,279,704 to Davenport; and 5,457,886 to Fuller. While these patents show some decorative exteriors, all of the exterior shapes and forms require engraving onto the metal hubcap itself so that the hubcap becomes a permanent fixture on the vehicle's wheels, and do not allow for having removable openings for allowing raised members such as valve stems and raised wheel portions to pass therethrough.

U.S. Pat. No. 2,548,070 to Ryan describes an advertising display device”, title, but requires permanent type forms of indicia to be used as stated by having “media . . . directly stamped onto the material itself or may be marked thereon by enameling, or by luminous paint”, column 3, lines 1-5. U.S. Pat. No. 5,316,376 to Defreitas describes a “decorative wheel cover”, title, but is restricted to attaching “mounted photograph or artwork”, abstract, to the “wheel cover.”

Various types of hubcaps and trim covers have also been used over the years, and have included an opening for valve stems. See for example, U.S. Pat. Nos.: 1,406,945 to Dunlap et al.; 1,446,561 to Harris; 3,397,918 to Aske, Jr. et al; and 4,344,654 to Apezynski. However, each of these devices is restricted to having a single fixed opening location for the valve stem and do not allow for passing different sized valve stems at different locations therethrough, nor for allowing for other raised wheel protrusions such as a raised hub member to pass therethrough.

Some types of external removable covers have also been proposed for vehicle wheels. See for example: U.S. Pat. Nos. 4,792,191 to Farmer and 4,955,670 to Koller. However, both of these patents are temporarily shields that are primarily used when the vehicle is stationary and allow the tires and cars to be cleaned and detailed. The Farmer '191 patent has a some small holes about a central portion of their cover but they are only used as finger holes for physically holding the cover, and not for allowing fixed protrusions such as valve stems or other raised wheel members to be able to protrude therethrough. Likewise, Koller has a central through-hole that is only used for holding the cover, and not for allowing fixed protrusions such as valve stems or other raised wheel members to protrude therethrough. Furthermore, these devices cannot be used when the vehicle is in motion.

The decorative wheel covers described above also do not provide for the problem of all types of existing protrusions on wheels. See for example: U.S. Pat. Nos. 2,548,070 to Ryan and 5,316,376 to Defreitas. None of these references allow for openings that would allow raised wheel protrusions such as valve stems and raised wheel members to pass therethrough.

The above devices referenced in the patents could also be dangerous in some wheel applications where internal wheel components such as brakes on many large vehicles such as buses, and trucks need to have air flow about the wheels in order to constantly air cooled. Many of the devices described above have additional problems. For example, by covering up most of the outside surface of the wheel hub areas with closed covers, the inside overheating of brake type components can occur causing damage to the vehicle.

None of the prior art patents has portions of the wheel cover that can be removed as desired for allowing various raised portions of the wheel such as different sized valve stems, raised wheel hub type members, and the like, to be able to pass therethrough. Also, none of the prior art addresses the problems of restricting the air flow to wheel brakes, by allowing the user to selectively punch out portions of the wheel cover as needed.

Finally, none of the prior art wheel covers allow for users to directly customize the wheel covers with all types of indicia from writings, to stick-on decals, static cling decals, magnetic signs, and the like, nor do these wheel covers have a washable surface for allowing new forms of indicia to be easily removed.

### SUMMARY OF THE INVENTION

A primary objective of the invention is to provide a decorative wheel cover for moving vehicles having a surface for allowing any customized form of indicia to be added thereon.

A secondary objective of the invention is to provide a decorative wheel cover for moving vehicles that allows for all types of indicia to be removable.

A third objective of the invention is to provide a decorative wheel cover that can come in a kit form including stencils and markers and ink/paint for customizing indicia thereon.

A fourth objective of the invention is to provide a decorative wheel cover having removable fasteners on both sides so that both decorative sides of the wheel cover can be interchanged over time.

A fifth objective of the invention is to provide a decorative wheel cover that can protect the wheel brakes from corrosion, rust, dirt, and the like.

A sixth objective of the invention is to provide a decorative wheel cover that can have at least one perforated portion that can be selectively removed by the user.

A seventh objective of the invention is to provide a decorative wheel cover for moving vehicles that can have different areas that can be removed to allow for raised protrusions on the wheel such as different sized air valve stems, raised center hubs, and the like, to pass therethrough.

An eighth objective of the invention is to provide a decorative wheel cover for moving vehicles that can have at least one portion that can be removed for allowing internal wheel components such as brakes to be cooled as needed.

A preferred version of the removable decorative wheel cover for covering wheel hubs on moving vehicles includes a thin rigid and pliable plastic disc for substantially covering an existing wheel hub of a vehicle. The novel discs can each have a diameter of approximately 13 inches to approximately 18 inches for vehicles such as cars and pickups, and approximately 18 to approximately 36 inches for large vehicles such as tractor trailers, semis, and the like, and approximately 6 inches to approximately 14 inches for golf carts. The disc can have a thickness of approximately 1/64 of an inch to approximately ½ of an inch.

The wheel cover can include a blank surface and can be formed from plastic, Plexiglas, metal, aluminum, colored plastic(i.e. white, green, blue, red, and the like), shiny material, high gloss material, and the like.

Versions of the wheel cover can have a continuous closed line of perforations in the disc allows a user to remove a small portion of material from the disc to form a through-hole therein. The decorative design/indicia on the cover does not necessarily overlap into the area bounded by the line of perforations. Fasteners such as hook and loop fasteners, snaps, and peel and stick tape allow the disc to removably attached to the existing wheel hub of the vehicle as needed.

Continuous closed lines of perforations form perforated patterns of different shapes such as substantially rectangular shape, a substantially circular shape, other shapes, and the like.

Users can selectively punch out one or more of the perforated patterns to create through-hole(s) in order to allow different sized raised protrusions on the wheel such as a valve stem, and a center raised hub member to pass therethrough. Additionally, through-holes can be selectively punched out to allow components that generate heat such as breaks to be air cooled by the through-hole opening(s).

The continuous lines of perforations can form a ring of individual perforated closed patterns adjacent to an outer perimeter of the disc, wherein individual openings can be spaced approximately ¼ of an inch to approximately 2 inches from the perimeter of the disc. The ring can include approximately 4 to approximately 8 individual perforated closed patterns. Using 4 to 6 closed patterns would allow each of the openings to have individual diameters of approximately 1 to approximately 2 inches. Using approximately 7 to approximately 8 individual perforated closed patterns would allow each of the openings to have individual diameters of approximately ½ to approximately 1 inch. The ring can include individual openings having non uniform diameters so that wheels having larger valve stems can be used with the disc.

The disc can also include a substantially central located closed pattern of perforations within the ring, which has a diameter of approximately 2 to approximately 4 inches.

Blank versions of the wheel covers can include a cover having a blank surface with removable fasteners on the opposite sides, blank surfaces on both sides and removable fasteners on both sides. Wheel covers having removable fasteners on both sides can also include indica one side and a blank on the opposite side, and indicia on both sides.

Users can selectively apply indicia to the wheel covers. Embodiments cover removable stickers, and decals, peel and stick decals, static cling decals, magnetic decals, stencil kits with markers, and brushes, and the like. Further objects and advantages of this invention will be apparent from the following detailed description of a presently preferred embodiment which is illustrated schematically in the accompanying drawings.

### BRIEF DESCRIPTION OF THE FIGURES

FIG. 1A shows a preferred embodiment of the novel wheel covers on the wheels of an automobile.

FIG. 1B shows the novel wheels of FIG. 1A on a pickup truck.

FIG. 2 is an enlarged view of a wheel cover of FIGS. 1A-1B, with a spiral design.

FIG. 3 is a front view of an existing exposed vehicle wheel hub of the preceding figures having strip fasteners attached thereto without a hubcap.

FIG. 4 is a rear view of the novel wheel cover of the preceding figures showing the matching strip fasteners.

FIG. 5 is a front view of another novel wheel cover of the subject invention.

FIG. 6 is a front view of still another novel wheel cover of the subject invention.

FIG. 7 is a front view of still another novel wheel cover of the subject invention.

FIG. 8 is a front view of still another novel wheel cover of the subject invention.

FIG. 9A is a side cross-sectional view of a flat wheel cover disc.

FIG. 9B is a side cross-sectional view of a domed wheel cover disc.

FIG. 9C is a side cross-sectional view of a hat-shaped wheel cover disc.

FIG. 10 shows a blank wheel cover for allowing indicia to be added thereon.

FIG. 11A shows a front view of another novel wheel cover with removable fasteners thereon.

FIG. 11B shows a rear view of the wheel cover of FIG. 11A with removable fasteners thereon.

FIG. 12 shows a decal with removable backing for use with the blank wheel covers.

FIG. 13 shows a static cling decal/magnetic decal for use with the blank wheel covers.

FIG. 14 shows a kit form of customized indicia for use with the blank wheel covers.

FIG. 15 shows a side view of a bus with the novel wheel covers of the subject invention.

FIG. 16 shows a side view of a full size truck with the novel wheel covers of the subject invention.

FIG. 17 shows a side view of a golf cart with the novel wheel covers of the subject invention.

### DESCRIPTION OF THE PREFERRED EMBODIMENTS

Before explaining the disclosed embodiments of the present invention in detail it is to be understood that the invention is not limited in its application to the details of the particular arrangement shown since the invention is capable of other embodiments. Also, the terminology used herein is for the purpose of description and not of limitation.

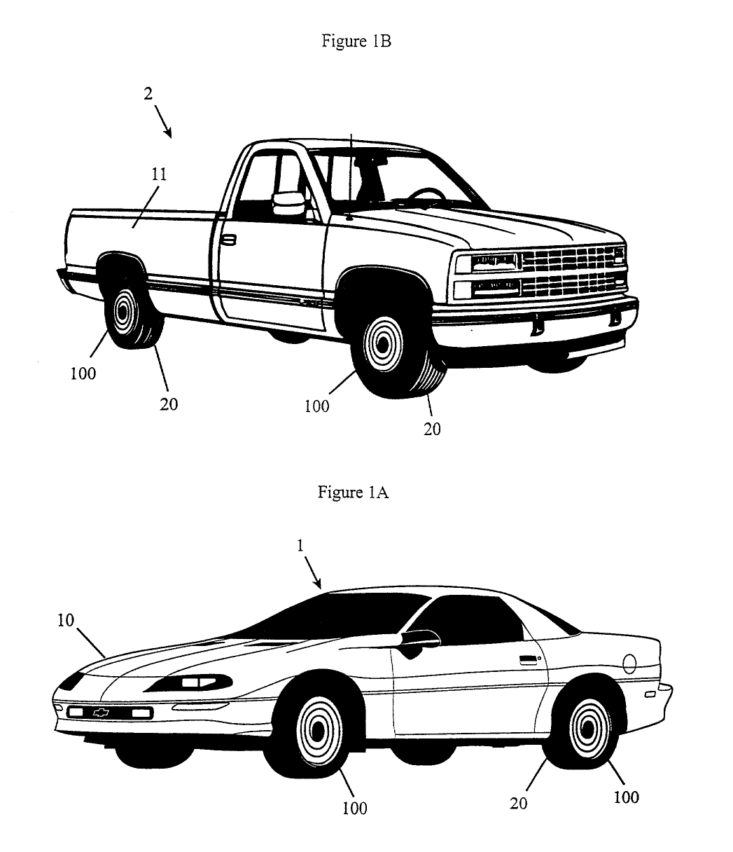

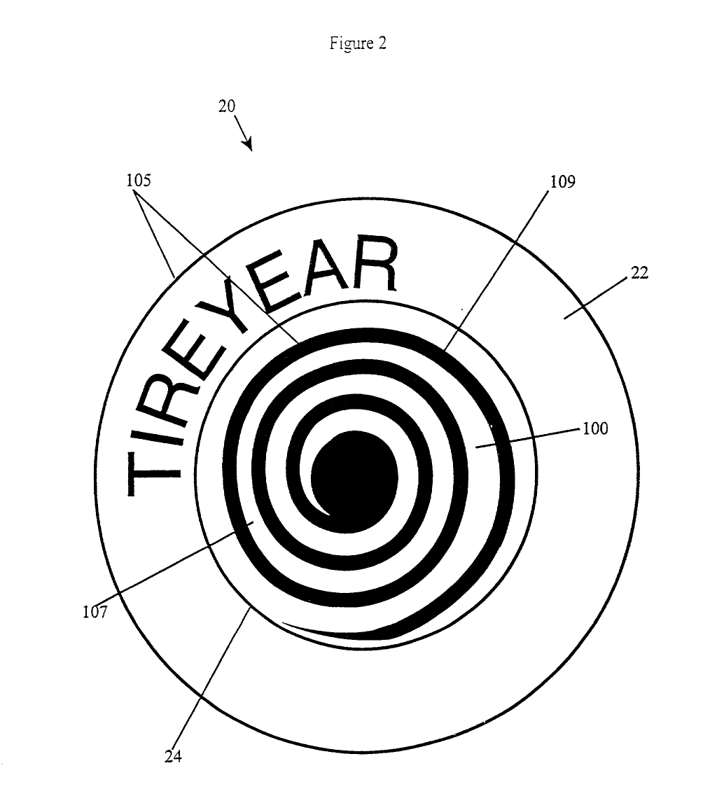

FIG. 1A shows a preferred embodiment 1 of the novel wheel covers 100, 100′ on the wheels 20, 20′ of an automobile 10. FIG. 1B shows the novel wheels 100, 100′ of FIG. 1A on the wheels 20, 20′ of a truck. FIG. 2 is an enlarged view of a wheel cover of FIGS. 1A-1B, with a spiral design 105, 107.

Referring to FIGS. 1A, 1B and 2, disc cover 100 can be approximately 13 inches to approximately 18 and ½ inches in diameter to fit over most wheel hubs 24. Other diameter sizes of approximately 18 to approximately 36 inches can be used to provide covers for other sized wheels, such as but not limited to tractor trailers, semis, and the like. Preferably disc cover 100 can have a thickness of approximately ½ mill (1/64 of an inch) to approximately 16 mills (½ of an inch). Pliable material used for the disc cover 100 can include but is not limited to PVC (poly vinyl carbonate), such as Sintra® manufactured by Alucobond Co. Generally, Sintra® is available in the colors of white, red yellow, blue and green. Other types of material that can be used include clear plastics, such as poly carbonate, such as one manufactured by Sheffield Plastics. Designs and/or indicia can be applied to the outer surface of the plastic by being screen printed, and by techniques described in U.S. Pat. No. 5,931,543 to Smith, which is incorporated by reference.

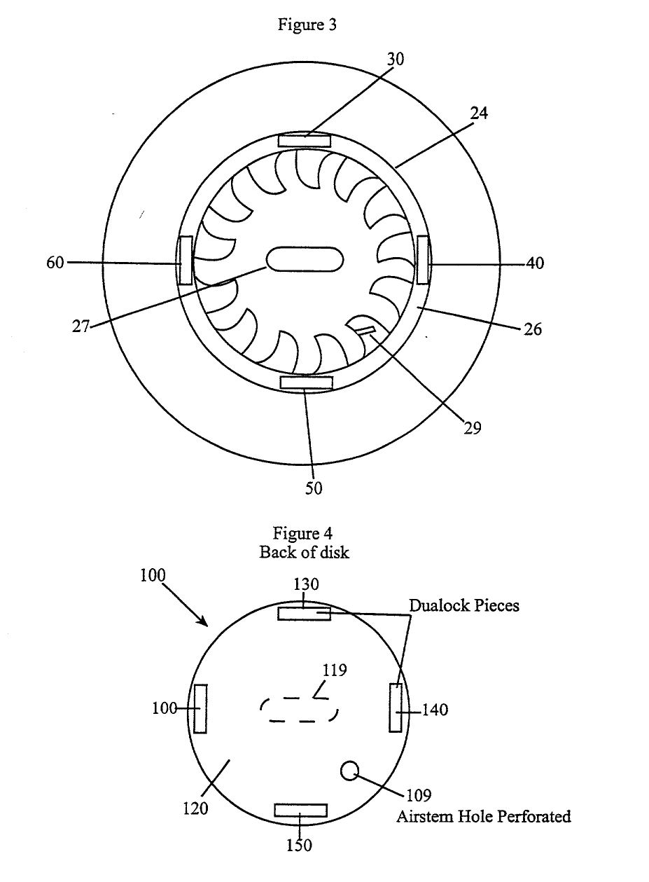

FIG. 3 is a front view of an existing exposed vehicle wheel hub 24 of FIG. 2 with outer ring 26 and raised air stem valve 29, and raised center hub member 27, and first strip fasteners 30, 40, 50, 60. FIG. 4 shows the back of the novel disc 100 of the subject invention. On most conventional vehicles such as automobiles, the outer flat ring portion 26 is approximately ¼ to approximately ½ inches wide. Note that the novel wheel covers 100 of the subject invention are mounted in place of a hubcap which are used to generally cover the wheel hubs. The invention can be mounted on the wheel hubs that have their hubcaps removed or alternatively on wheel hubs that do not have hubcaps. Still furthermore, the novel wheel covers 100 can be directly mounted over the hubcaps. A perforated pattern 109 in the shape of a circle, oval, and the like, adjacent to the outer edge of the disc 120, is for the raised airstem valve 29 of the wheel 20. A perforated pattern 119 in the shape of a oval, rectangle, and the like, that is substantially located in the center of the disc 120, can be punched out for the raised center hub 27 of the wheel 20.

The strips 130, 140, 150 and 160 in FIG. 4 can be matching hook and loop fasteners for the hook and loop fastener strips 30, 40, 50 and 60 on the rim 26 shown in FIG. 3. Alternatively, strong peel and stick tape, such as but not limited to UHB tape by 3-M® can be used for these fasteners in order to removably hold the disc to the wheel.

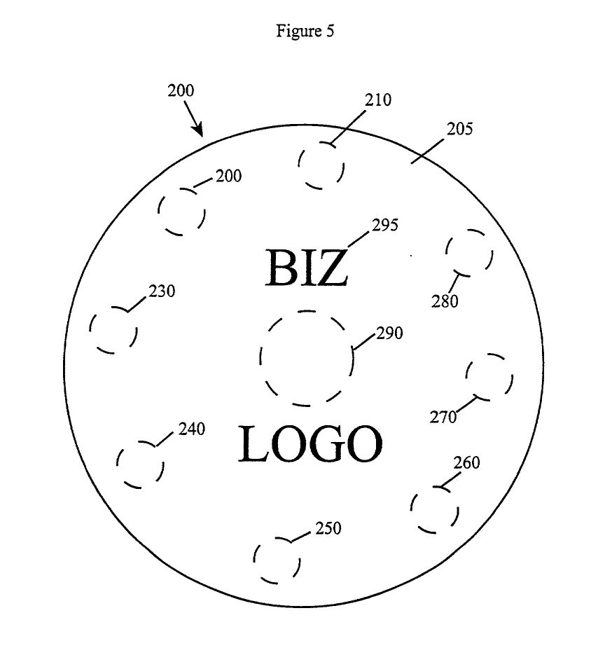

FIG. 5 shows another embodiment of the novel wheel cover invention. Here, up to eight perforated patterns 210, 220, 230, 240, 250, 260, 270 and 280 each having diameters of approximately 1 inch, can be spaced approximately ¼ to approximately 2 inches from the side edge of the disc 205, and be arranged in a ring pattern. A centrally located perforated pattern 290 can have a diameter of approximately 2 to approximately 4 inches. The user can punch out anyone of the outer edge patterns 210-280 for allowing tire valve stems to protrude therefrom. The centrally located pattern 290 can likewise be punched out to create a through-hole for a raised center hub member on a wheel. Additionally, anyone of the patterns 210-290 can be punched out in order to circulate air to heat generating components such as breaks on large vehicles, such as but not limited to buses and trucks. It is important to note that the decoration indicia such as a business name 295 can be positioned away from the perforated patterns 210-290. Thus, punching out a through-hole will not effect the advertisement that can be placed on the novel covers.

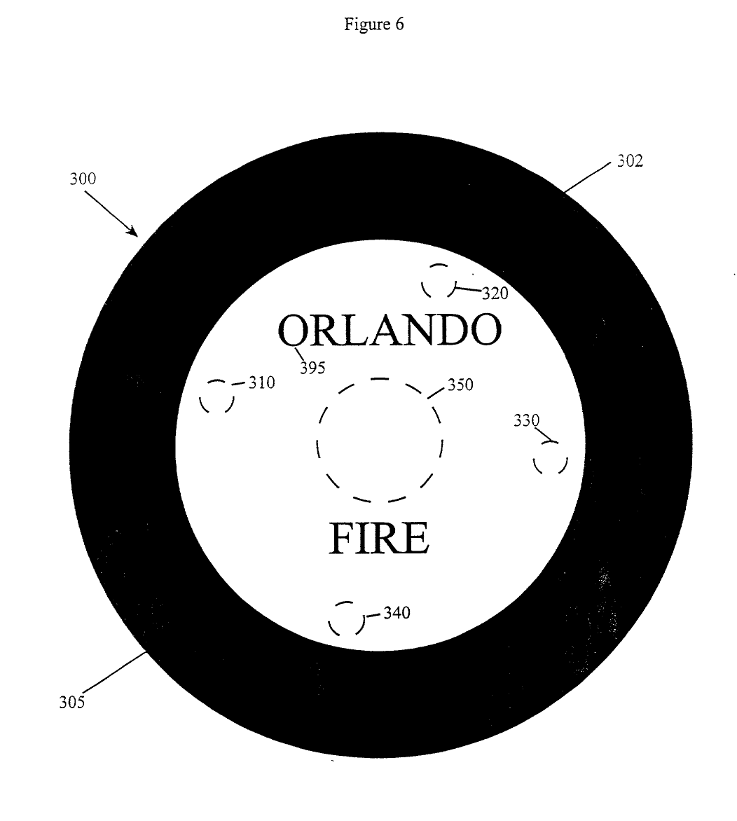

FIG. 6 shows another embodiment of the novel wheel cover 300 mounted on a wheel 302. Disc 305 includes outer edge perforated patterns 310, 320, 330 and 340, each of which can have a diameter of approximately 1 to approximately 1 & ½ inches, and a centrally located perforated pattern 350 with the remaining dimensions similar to those described above. Indicia 395 can also be located so that punching out any of the perforated patterns will not effect the message 395 on the cover 305.

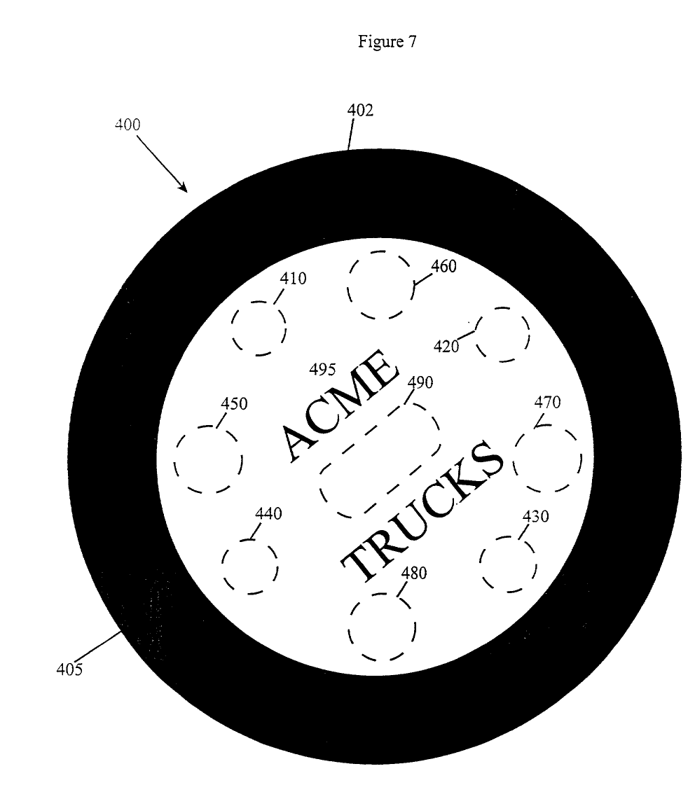

FIG. 7 shows another embodiment 400 of the novel wheel cover invention. A disc cover 405 can be mounted on a wheel as previously described. Outer edge perforated patterns can be in a ring shape and include different diameters so that the diameters of perforated patterns 410, 420, 430, 440 are different from those of patterns 450, 460, 470, 480. For example, patterns 410-440 can have a diameter of approximately ½ inch, while patterns 450-480 can have a diameter of approximately 1 and ½ inches to handle different sized raised tire valve stems. Additionally, the central perforated pattern can be rectangular, oval, and the like, and have various sized dimensions to handle any dimensions of a raised central hub portion of the underling wheel 402.

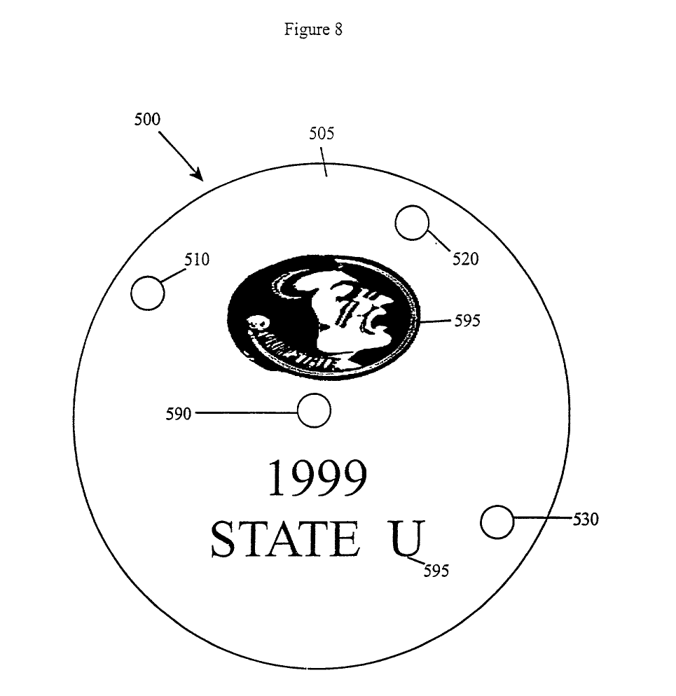

FIG. 8 shows still another embodiment 500 of the novel wheel cover invention. Wheel cover 500 includes a disc shape 505, three outer edge perforated patterns 510, 520, 530, center perforated pattern 590, and indicia advertisement 595.

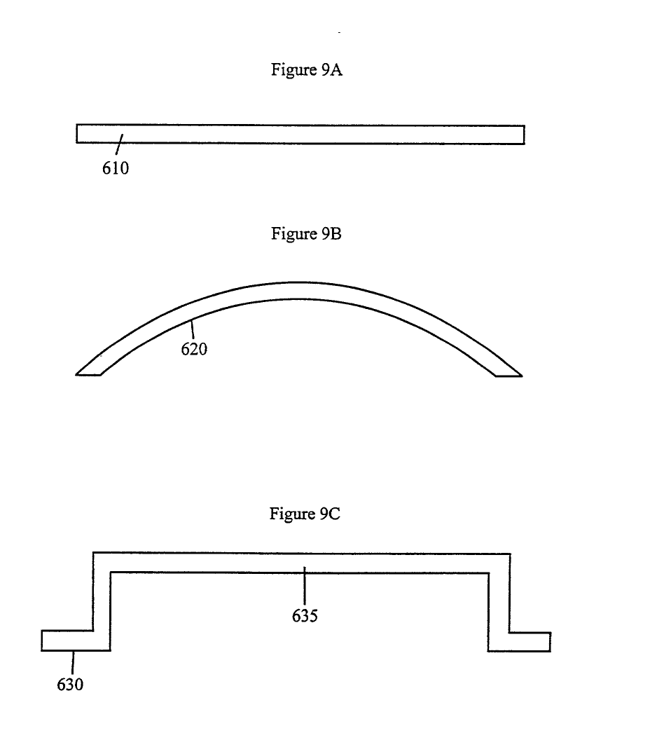

FIG. 9A is a side cross-sectional view of a flat wheel cover disc 610 that can use any of the perforated patterns previously described.

FIG. 9B is a side cross-sectional view of a domed wheel cover disc 620 that can use any of the perforated patterns previously described.

FIG. 9C is a side cross-sectional view of a hat-shaped wheel cover disc 630, 635 that can use any of the perforated patterns previously described. Vehicle wheels having raised components can be selectively covered by the dome and hat shapes.

The indicia type design on the external side of the wheel cover is generally not intended to cross over the closed line of perforation patterns. Thus, if the user punches out any of the perforated openings, the design(s) on the disc cover is not effected. The designs can be chosen from optical illusions such as a spiral design, such as the one described in U.S. Pat. No. 5,931,543 to Smith, which is incorporated by reference. Additionally, the design can be a business identifier, sports team identifier, educational school identifier, wherein the identifiers can be a name, a logo, a design, combinations thereof, and the like.

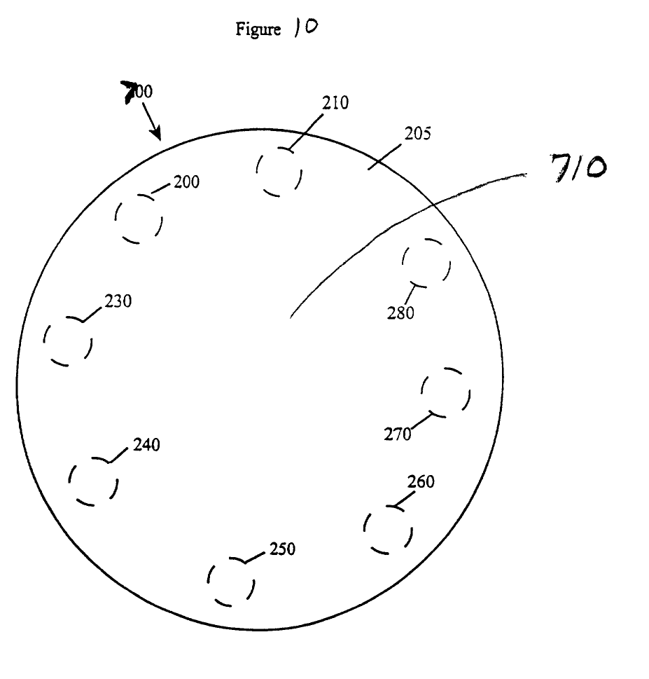

FIG. 10 shows a novel blank wheel cover 700 for allowing indicia to be added thereon. Wheel cover 700 can include any number of perforated patterns therethrough such as those described in reference to FIG. 5. Here, wheel cover 700 includes a blank portion 710 for allowing the user to customize any indicia that the user selects. Wheel cover 700 can be formed from plastic, clear Plexiglas, and the like, as described in the previous embodiments. In addition to the materials previously described, the blank covers can be formed form other materials such as but not limited to composites and the like. Additionally, blank wheel cover 700 can be have a colored surface background such as but not limited to white, yellow, green, blue, black, and the like. Additionally, wheel cover 700 can include a surface having a shine and gloss finish, and/or have glow in the dark features, and/or reflective ink/vinyl, and/or include pre-printed backing patterns. Wheel cover 700 is intended to include a portion 710 that allows for the user to selectively add indicia thereon.

Although FIG. 10 only shows the perforated patterns from FIG. 5, the wheel cover 700 can include any of the other perforated patterns previously described, and can additionally have no perforated patterns, one pre-made cut-out for either or both a valve stem and a raised wheel hub protrusion, and the like.

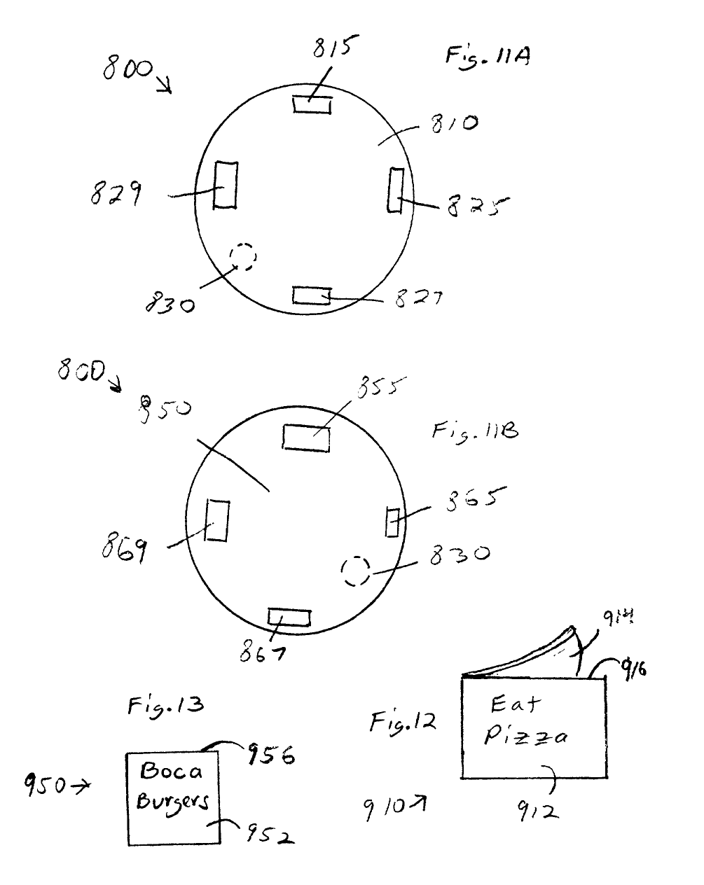

FIG. 11A shows a front view of another novel wheel cover 800 with removable fasteners 815, 825, 827, 829 thereon. FIG. 11B shows a rear view of the wheel cover 800 of FIG. 11A with removable fasteners 855, 865, 867, 869 thereon. Referring to FIGS. 11A-11B, wheel cover 800 includes two sides 810 and 850 each having removable fasteners thereon, for allowing the user to selectively switch which side is being visible on the vehicle wheel. Either the first side 810 or the second side 850 or both sides can have indicia already located thereon. Additionally, either the first side 810, or the second side 850 or both sides can have blank portions thereon for allowing the user to selectively apply indicia to that surface(s). The removable fasteners 815, 825, 827, 829, 855, 865, 867, 869 can be various removable fasteners such as but not limited to peel and stick tape, hook and loop fasteners, magnetic fasteners, and the like, that allow the wheel cover to stay on the vehicle while the vehicle is moving. Although, four removable fasteners are shown on each side, less than four or greater than four fasteners can be used by the user as needed. Additionally, although one perforated pattern 830 is shown, no perforated patterns or up to any number of perforated patterns as disclosed previously can be used.

FIG. 12 shows a decal 910 having indicia on one side 912 with a removable backing 914 for use with the blank wheel covers described above. The removable backing 914 can come be removed from a peel and stick rear surface 916 on the decal. Additionally, the peel and stick surface 916 can also allow for the decal 910 to be easily removable from the wheel covers as needed.

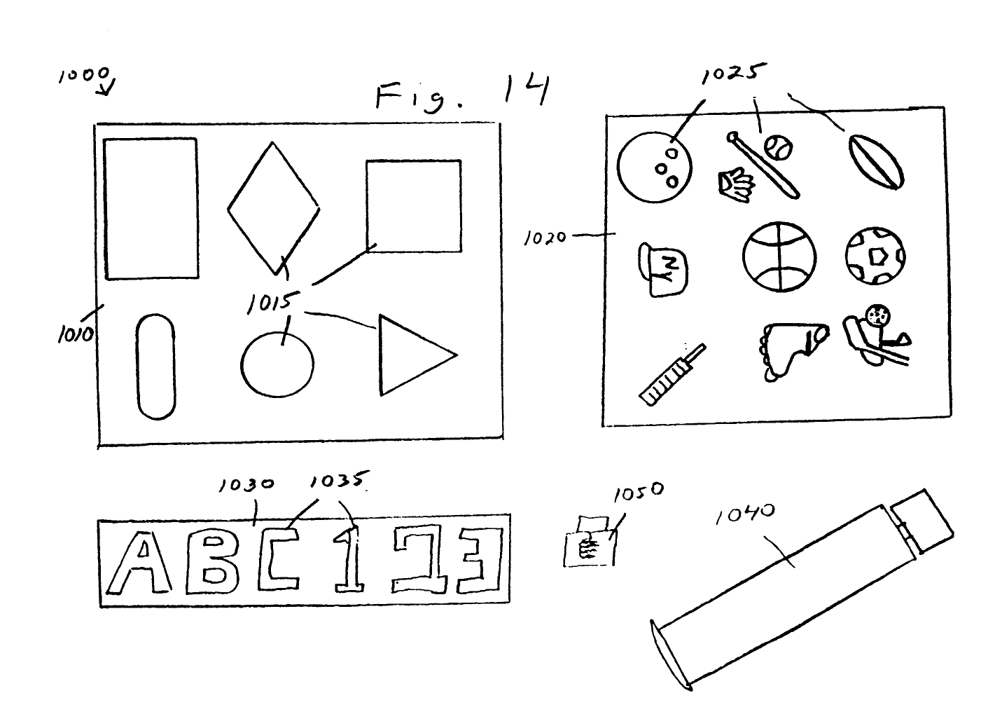

FIG. 13 shows a static cling decal 950 for use with the blank wheel covers described above. One side of the decal 950 can include indicia 952 thereon, and the rear side 956 for being applied to the novel wheel covers previously described. Static cling decal 950 can be formed from a sheet of micro-perforated static cling vinyl such as but not limited to static cling decals sold by Vision Graphics of Statesville, N.C., at visiongraphic.com.

Decal 950 can be a pliable magnetic decal such as a rubberized type decal having indicia thereon. In the case of using a magnetic decal, a portion of the surface on the wheel cover can include a magnetic surface, such as magnetic tape, a metal pliable layer, a metal paint layer, and the like.

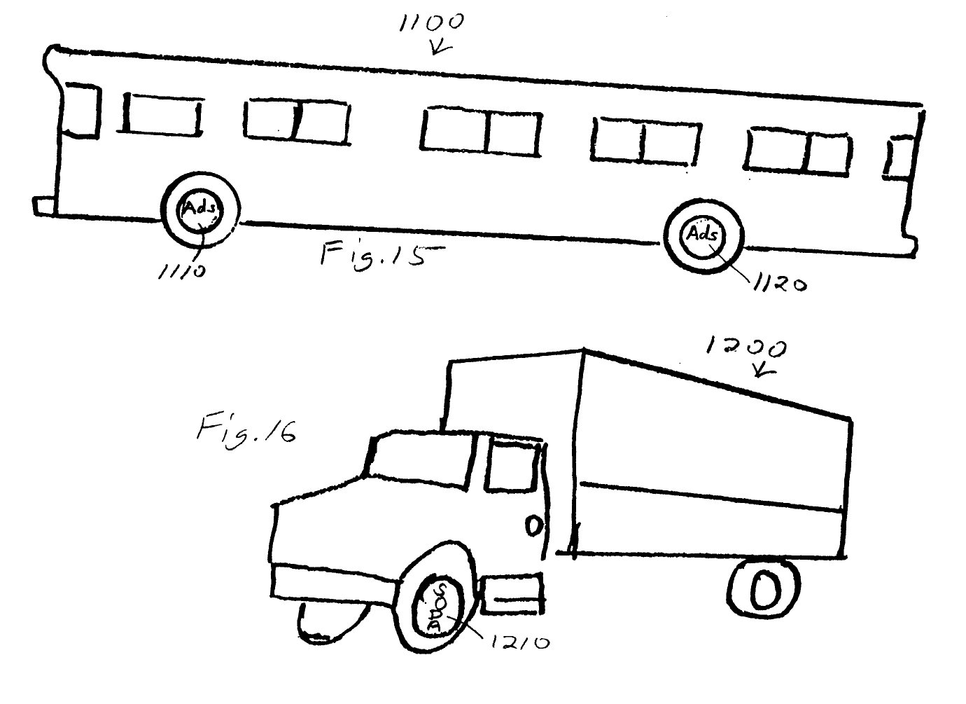

FIG. 14 shows a kit 1000 of customized indicia for use with the blank wheel covers described above. The kit 1000 can stencils such as but not limited to a stencil 1010 having cut-outs of different shapes 1015 such as but not limited to rectangles, diamonds, squares, circles and triangles, and the like; stencil 1020 having cut-outs of different sports patterns 1025 such as but not limited to bowling ball, baseball bat, baseball glove, baseball, football, sports cap, basket ball, soccer ball, ice skates golf club, golf ball, and the like; and stencil 1030 having cut-outs 1035 of different number letters and/or numbers, to be used by the user. Kit 1000 can also include a marker 1040 such as a washable magic type marker of different colors such as but not limited to black, blue, and the like. Additionally, or alternatively, kit 1000 can include an ink/paint type container 1050 having a brush for allowing applying the selected stencil pattern thereon. Although the kit is described as having cutout patterns in the stencils, the kit can include sheet(s) of different removable decals thereon.

Additionally, the wheel covers themselves, can have surface(s) formed from material such as dry-erase board material such as but not limited to a blackboard material, and include a dry-erase marker such as markers, chalk, and the like.

FIG. 15 shows a side view of a bus 1100 with the removable novel wheel covers 1110, 1120 of the subject invention. Any version of the novel wheel covers previously described can be used with a bus for allowing bus wheels to have visible indicia thereon, and to allow bus wheels a further surface for advertisements, and the like.

FIG. 16 shows a side view of a full size truck 1200 with the novel wheel covers 1210 of the subject invention. Any version of the novel wheel covers previously described can be used with a truck for allowing truck wheels to have visible indicia thereon, and to allow the truck wheels a further surface for advertisements, and the like.

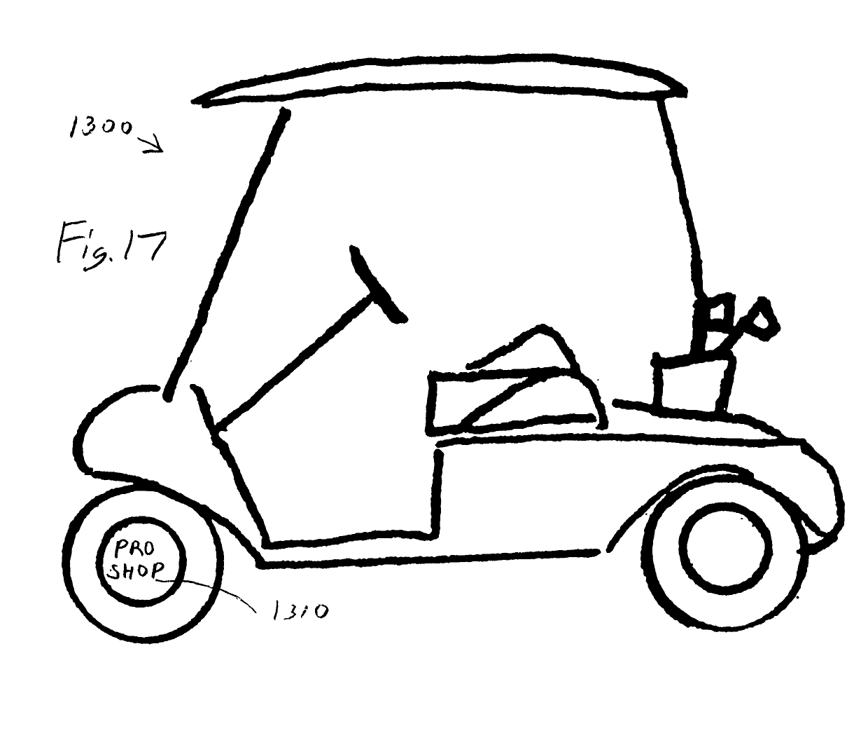

FIG. 17 shows a side view of a golf cart 1300 with the novel wheel covers 1310 of the subject invention. Any version of the novel wheel covers previously described can be used with a golf cart for allowing the golf cart wheels to have visible indicia thereon, and to allow the golf cart wheels a further surface for advertisements, and the like. For golf cart use, any of the novel wheel covers previously described can be sized to fit golf cart wheels. For example, if a golf cart wheel is approximately six(6) inches to approximately 14(fourteen) inches in diameter, then the wheel covers can be sized accordingly.

The blank wheel covers allow the users to change out decals, stickers periodically, over time.

Although the decals are described for use with the blank wheel covers, the decals can be used with any of the previous embodiments, and be used to cover up existing indicia on the wheel covers. And although the decals are described as having indicia thereon, the decals can have blank portions that would allow the user to further customize the surface with the stencils and markers previously described.

Additionally, the wheel covers and decals/stickers and markable surfaces can be used directly over existing hubcaps using any of the embodiments previously described.

While the discs are preferably formed from plastic, the discs can be made from other durable type materials having waterproof and weather resistant exterior surfaces.

Although, dimensions for the diameter of the disc were described previously, the novel disc cover can be sized for larger applications such as for large wheels on multi-wheeler tractor trailers, and the like.

The novel wheel covers can also be used to function like a hubcap to protect a wheel's brakes from corrosion, rust, dirt, and the like, caused by air, sea air, fresh water, seawater, and the like.

The indicia used with the subject invention can include all types of indicia such as but not limited to flags, advertisements, logos, words, letter(s), number(s), symbols, and the like, as selected by the user.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim:

1. A removable decorative wheel cover for covering wheel hubs on moving vehicles, comprising:
a thin rigid and pliable disc for substantially covering an existing wheel hub of a moving vehicle, the disc having a blank surface portion for allowing indicia to be selectively added by a user; and
a fastener on one side of the disc for allowing the disc to removably attached to the existing wheel hub of the moving vehicle.

2. The removable decorative wheel cover of claim 1, wherein the indicia includes:
a stencil having at least two different forms of indicia for being selectively applied by the user.

3. The removable decorative wheel cover of claim 2, further comprising:
a marker for using the stencil.

4. The removable decorative wheel cover of claim 1, wherein the blank portion includes:
a washable material for allowing the indicia to be selectively removed.

5. The removable decorative wheel cover of claim 1, wherein the indicia includes:
a decal having a peel and stick backing for being applied to the wheel cover.

6. The removable decorative wheel cover of claim 1, wherein the indicia includes:
a decal with a static cling backing portion for being selectively attached to the wheel cover.

7. The removable decorative wheel cover of claim 1, wherein the indicia includes:
a decal with a backing portion having a removable fastener for being selectively attached to the wheel cover.

8. The removable decorative wheel cover of claim 1, wherein the indicia includes:
a decal with a magnetic backing for being selectively attached to the wheel cover.

9. The removable decorative wheel cover of claim 1, further comprising:
a perforated pattern through the disc for allowing a user to selectively remove at least one small portion of material from the disc to form a through-hole therethrough therein, wherein the through-hole is selectively created by the user to allow a valve stem of the wheel hub of the wheel to protrude therethrough.

10. The removable decorative wheel cover of claim 1, further comprising:
at least one perforated pattern through the disc for allowing a user to selectively remove at least one small portion of material from the disc to form a through-hole therethrough therein, wherein the through-hole is selectively created by the user to allow at least one of: a valve stem, and a raised portion of the wheel hub of the wheel to protrude therethrough.

11. The removable decorative wheel cover of claim 1, further comprising:
at least two separated perforated patterns through the disc for allowing a user to selectively remove at least one small portion of material from the disc to form a through-hole therethrough therein, wherein the through-hole is selectively created by the user to allow a valve stem of the wheel to protrude therethrough.

12. The removable decorative wheel cover of claim 1, further comprising:
a second fastener on another side of the disc for allowing both sides of the disc to be removably attached to the existing wheel hub of the vehicle.

13. The removable decorative wheel cover of claim 12, wherein the another side includes:
a blank portion.

14. The removable decorative wheel cover of claim 13, wherein the another side includes:
different indicia than the indicia on the one side of the disc.

15. The removable decorative wheel covers of claim 1, the vehicle includes: an automobile.

16. The removable decorative wheel covers of claim 1, the vehicle includes: a truck.

17. The removable decorative wheel covers of claim 1, the vehicle includes: a bus.

18. The removable decorative wheel covers of claim 1, the vehicle includes: a golf cart.

19. A removable wheel cover for covering wheels on moving vehicles, comprising:
a wheel on a vehicle, the wheel having a wheel hub;
a thin rigid and pliable disc for substantially covering the wheel hub, the disc having a front side and rear side;
a first fastener on the rear side of the disc for allowing the rear side of the disc to be removably attached to the wheel hub and for keeping the disc on the wheel hub while the vehicle is moving, and for allowing the front side of the disc to be selectively visible; and
a second fastener on the front side of the disc for allowing the front side of the disc to be removably attached to the wheel hub and for keeping the disc on the wheel hub while the vehicle is moving, and for allowing the rear side of the disc to be selectively visible.
